(19) United States
(12) Patent Application Publication
(10) Pub. No.: US 2026/0229155 A1
(43) Pub. Date: Aug. 6, 2026

(54) TECHNIQUES FOR DYNAMIC CONTROL OF DIMMING FOR DISPLAY DEVICES

(71) Applicant: Microsoft Technology Licensing, LLC, Redmond, WA (US)

(72) Inventors: Chang Joon PARK, Sunnyvale, CA (US); Brock M. Roland, San Bruno, CA (US); Glen Patrick Gordon, Graham, WA (US); Poon Yarn Chee, Redmond, WA (US); Justin Yuyang Ye, Sunnyvale, CA (US); Michael Shi, Camano Island, WA (US)

(21) Appl. No.: 19/043,253

(22) Filed: Jan. 31, 2025

(51) Int. Cl. G09G 3/00

(52) U.S. Cl. CPC G09G 3/003; G09G 2320/0626; G09G 2330/021; G09G 2354/00; G09G 2360/144

(57) ABSTRACT

Described are examples for controlling a dimming panel for a display device. A first indication of a measured amount of ambient light can be received. A second indication of a location at which an eye is gazing can be received. A power control signal can be transmitted to a section of the dimming panel that corresponds to the location to facilitate activating dimming in the section of the dimming panel.

### BACKGROUND

Mixed reality (MR) devices include a wearable display device having a display that allows transmission of ambient light to facilitate viewing an environment outside of the wearable display device while also allowing for displaying holographic images over the environment. MR devices are increasing in demand and are usable for a multitude of applications, such as gaming, education, simulation, and the like. MR devices may include brightness control or backlighting to adjust a contrast ratio of the display to account for high levels of ambient light, where a higher contrast ratio may improve the viewability of holographic images on the display. Wearable MR devices, however, may be susceptible to power limitations due to their small form factor design, and increasing brightness or backlighting in this regard may have a significant impact on the power consumption, and thus battery life, of wearable MR devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, an apparatus for controlling a dimming panel for a display device is provided that includes one or more processors configured to receive a first indication of a measured amount of ambient light, receive a second indication of a location at which an eye is gazing, and modify a light transmittance in a section of the dimming panel that corresponds to the location.

In another example, a method for controlling a dimming panel for a display device is provided that includes receiving a first indication of a measured amount of ambient light, receiving a second indication of a location at which an eye is gazing, and transmitting, to a section of the dimming panel that corresponds to the location, a power control signal to modify a light transmittance.

In another example, a non-transitory computer-readable device is provided that stores instructions thereon that, when executed by a computing device, cause the computing device to perform operations for controlling a dimming panel for a display device including receiving a first indication of a measured amount of ambient light, receiving a second indication of a location at which an eye is gazing, and transmitting, to a section of the dimming panel that corresponds to the location, a power control signal to modify a light transmittance.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a system level block diagram of an example of a dimming panel for use with a display device, in accordance with aspects described herein.

FIG. 2 is a system level block diagram of an example of a dimming panel that includes switching functionality for activating or deactivating signaling to sections of the dimming panel, in accordance with aspects described herein.

FIG. 3 is an example of a signal waveform for achieving panel bias by using alternating forward and reverse bias over time to achieve a panel bias, in accordance with aspects described herein.

FIG. 4 is a block diagram of an example dimming panel control architecture for use with a display device, in accordance with aspects described herein.

FIG. 5 is a flowchart of an example of a method for operating a dimming panel, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to controlling dimming for a dimming panel of a display device. The dimming panel may include multiple sections that are independently dimmable over the display device to cause dimming in one or more corresponding sections of the display device. Dimming sections of the dimming panel in this regard, as opposed to diming the entire dimming panel, can decrease power consumption caused by the dimming. In an example, a dimming panel is provided that can be situated adjacent to and/or as a layer of a display device to control ambient light transmittance of one or more portions of the display device. The dimming panel can achieve independent dimming of the multiple sections by sending power signals to one or more given sections to activate or deactivate dimming, to facilitate controlling an amount of ambient light transmission through each of the one or more given sections. Each section of the dimming panel can include one or more electrodes for receiving the power signals to activate or deactivate dimming in the associated section.

In an example, the dimming panel can receive input from an eye-tracking sensor, which may be provided by the display device or the dimming panel, for tracking gaze of an eye at a portion of the display device or dimming panel. For ease of discussion, a single eye tracking sensor is described, however, it should be understood that the display device may include two eye tracking sensors and the dimming panel may include separate portions corresponding to a viewing area of each eye of the user wearing the display device. The dimming panel can be controlled to activate dimming on a section of the dimming panel that corresponds to a location of the gaze of the eye. In addition, for example, the dimming panel can be controlled to activate dimming on a section of the dimming panel that corresponds to a location at which an image is displayed on the display device. In a typical case, the location at which the image is displayed is the same as or similar to the location of the gaze of the eye. For example, the display device may include a mixed reality (MR) device that displays holographic images, and the section of the dimming panel corresponding to the location (and/or content or size) of the holographic image on the MR device can be dimmed to improve the contrast ratio for viewing the holographic image. Additionally, the dimming panel can receive input of an amount of ambient light from a light sensor, where an amount of dimming is a function of the amount of ambient light. In this regard, the selective dimming of one or more sections of the dimming panel can allow for conserving power while achieving a desirable contrast ratio for one or more holographic images displayed on the display device, which improves the user experience, such as in high ambient light conditions.

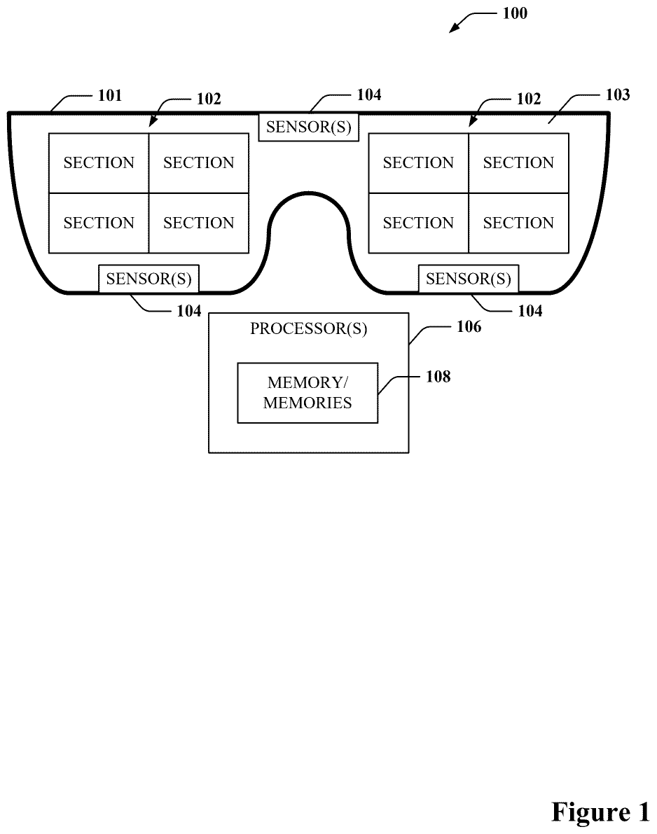

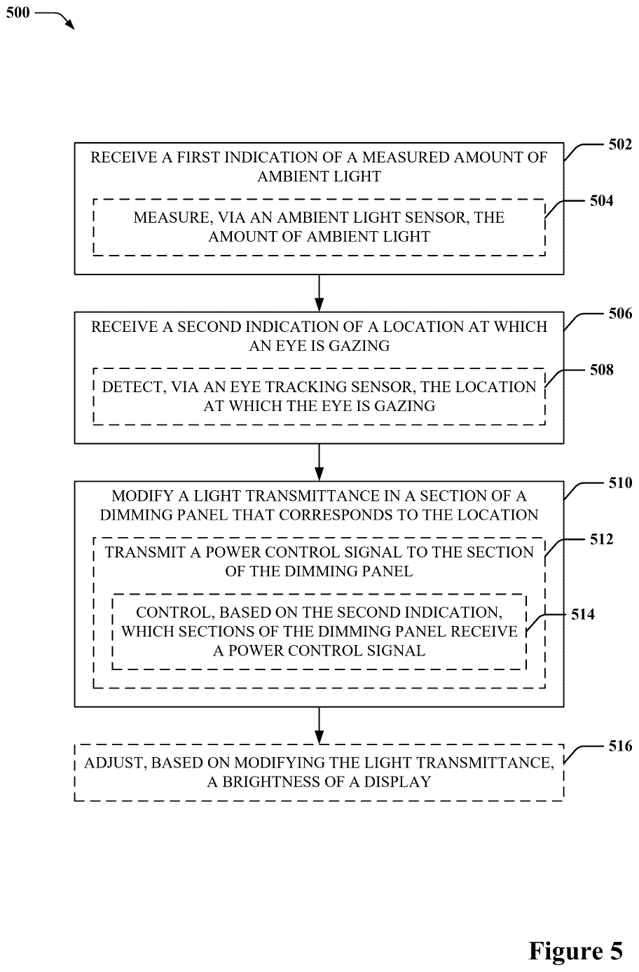

Turning now to FIGS. 1-5, examples are depicted with reference to one or more components and one or more methods that may perform the actions or operations described herein, where components and/or actions/operations in dashed line may be optional. Although the operations described below in FIG. 5 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions. As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

FIG. 1 is a system level block diagram of an example of a dimming panel 100 for use with a display device 101, in accordance with aspects described herein. For example, dimming panel 100 can be integrated within a display 103 of the display device 101, overlaid on the display 103 of the display device 101, and/or the like, such that the dimming panel 100 can provide a dimmable layer between ambient light and a view point (e.g., the eyes of a user viewing the display device 101). The dimming panel 100 can include multiple dimmable sections 102, which are independently dimmable by sending signals to a given section. Each section 102 can include one or more electrodes for receiving signals for activating or deactivating dimming at the section. For example, the sections 102 may include a layer composed of liquid crystal (LC), which may include a dye (e.g., a guest host (GH)-LC), where the LC and/or dye can be activated by an applied voltage to cause a dimming or darkening effect in the section 102. For example, the dimming panel 100 can be a GH-LC or Electrochromic transmittance controllable dimming device.

In a specific example, the dimming panel 100 is provided for the display device 101 included in or forming a MR device, or other heads-up display (HUD), or Augmented Reality (AR) Goggle and Glass formfactor. For example, the MR device can be worn by a user for viewing ambient light outside of the MR device, e.g., a real world environment or “reality,” and also holographic images displayed by a display device in the MR device in addition to the ambient light, which can provide a holographic effect of the image being displayed over reality viewed outside of the MR device. In this example, the dimming panel 100 can be overlaid on the display 103 of the MR device between the ambient light and the view point (e.g., eyes of a user of the MR device) to allow for modifying a transmittance of the ambient light through the display 103 of the MR device. In an example, the dimming panel 100 can be a separate device with its own processing capabilities to provide selective dimming in sections of the dimming panel 100 that correspond to sections of the display 103 of the MR device. In another example, the dimming panel 100 can be integrated within the MR device and its processing capabilities to provide the selective dimming in sections of the dimming panel 100, as described herein. Though shown in the shape of a MR device or HUD for a MR device, the dimming panel 100 can be of substantially any shape and used with substantially any display device to provide dimming of ambient light between the display device and a user viewing the display device. Moreover, though dimming panel 100 is shown with four sections 102 in each of a left side and right side, each side corresponding to an eye of a user using the MR device, the dimming panel 100 can include substantially any number of sections 102 and, depending on the type of display, may or may not be separated into left and right sides.

In an example, the dimming panel 100 may include, or may otherwise be communicatively coupled with, one or more sensors 104. The dimming panel 100 can receive input data from the one or more sensors 104 and can control the dimming based on the input data. For example, the one or more sensors 104 can include an eye tracking sensor for tracking eye gaze or eye movement of an eye of a user. For example, the eye tracking sensor can provide a location of eye gaze relative to the dimming panel 100, and the dimming panel 100 can determine which section(s) 102 of the dimming panel 100 to dim based on the location of eye gaze. In another example, the one or more sensors 104 can include an ambient light sensor for measuring an amount of ambient light. For example, the dimming panel 100 can determine an amount of dimming to apply based on the amount of ambient light to achieve a contrast ratio. In one example, the dimming panel 100 can determine the amount of dimming further based on a selectable dimming level parameter, which a user can configure through software, a hardware switch on the dimming panel, etc.

In an example, the dimming panel 100 may also include, or may otherwise be communicatively coupled with, one or more processors 106 and/or a memory/memories 108 for providing functionality described herein. For example, the memory/memories 108 can include instructions for, and/or processor(s) 106 can execute, function described herein such as operating or communicating with one or more sensors 104 to receive input data, sending signals to one or more sections 102 of the dimming panel 100, and/or the like. In one example, the processor(s) 106 and/or memory/memories 108 can execute instructions to receive or measure an amount of ambient light from one or more sensors 104, and/or receive a location corresponding to eye gaze tracked by one or more sensors 104. The processor(s) 106 and/or memory/memories 108 can execute instructions to activate dimming in one or more sections 102 of the dimming panel by transmitting a power control signal to the one or more sections 102, which can be based on determining the one or more sections 102 corresponding to a location of the eye gaze and/or based on determining a level of dimming for the measured amount of ambient light. As the eye tracking sensor tracks movement in eye gaze to other locations, the processor(s) 106 and/or memory/memories 108 can execute instructions to activate dimming in other sections 102 of the dimming panel 100 (and/or deactivate dimming in some sections 102 of the dimming panel 100). In addition, as the amount of ambient light changes, the processor(s) 106 and/or memory/memories 108 can execute instructions to increase or decrease the amount of dimming to account for the amount of ambient light.

In an example, the processor(s) 106 can additionally adjust (e.g., reduce) display brightness of the display 103 based on enabling the dimming feature, which can conserve overall system power of the display device 101 with improved contrast ratio target. In some examples, described herein, the dimming panel 100 can be part of the display device 101, and processor(s) 106 can accordingly adjust (e.g., reduce) the brightness of the display 103 based on detecting the dimming panel 100 activating dimming. In some examples, described herein, the dimming panel 100 may be a separate device, and processor(s) 106 can send information to the display device 101 indicating one or more parameters associated with activating the dimming, based on which the display device 101 can adjust (e.g., reduce) brightness of the display 103.

In an optional or additional aspect, which may be combined with any of the above-described features, the processor(s) 106 and/or memory/memories 108 can include and/or can be configured to execute instructions to generate and display an image on the display 103 of the display device 101. For example, the instructions may be a mixed reality program, and the image may be used to create a mixed reality scene on the display 103 when a user is viewing a real world environment through the display device 101. In other words, the processor(s) 106 and/or memory/memories 108 can be configured to implement the display device 101 as a MR device.

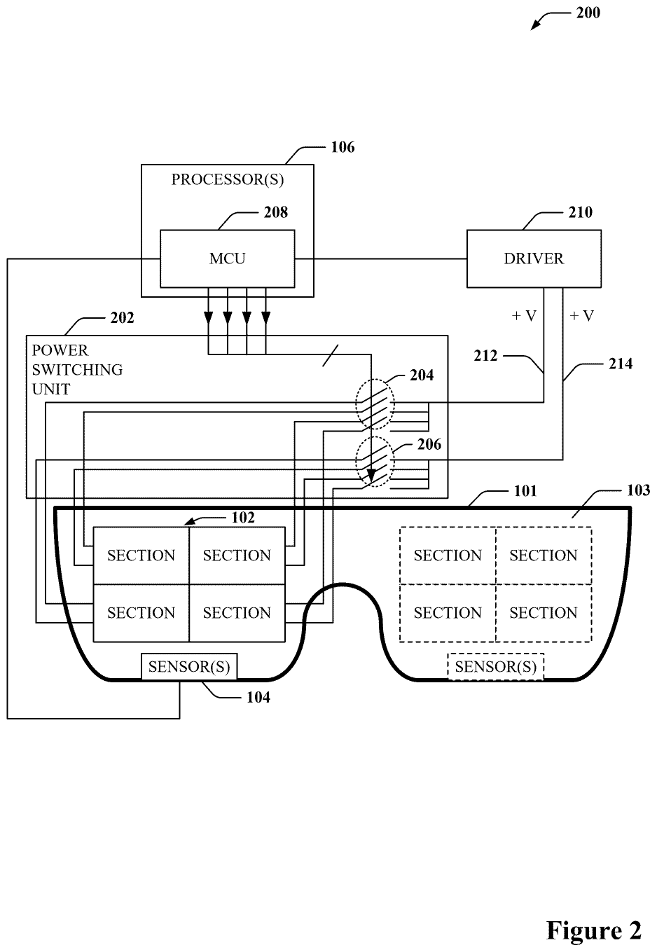

FIG. 2 is a system level block diagram of an example of a dimming panel 200 that includes switching functionality for activating or deactivating signaling to sections 102 of the dimming panel 200, in accordance with aspects described herein. Dimming panel 200 can be the same as or similar to dimming panel 100, and is one example of a specific implementation of dimming panel 100. For example, dimming panel 200 can include a power switching unit 202 for activating or deactivating power switches to each of the sections 102 of the dimming panel 200 based on received control signaling. In this example, power switching unit 202 can include power switches defined as a first set of switches 204 and a second set of switches 206 that can be activated for respectively applying forward and reverse bias voltage signals on positive and negative electrodes (also referred to herein as terminals) of the sections 102. Though FIG. 2 only depicts and describes control of the sections 102 of a left side of the dimming panel 200, similar components can be used to also control the sections 102 of the right side of the dimming panel 200, in accordance with aspects described herein.

Processor(s) 106 can include, or can otherwise provide, a microcontroller control unit (MCU) 208 for receiving input signals from the one or more sensors 104 and/or for controlling a driver 210 for providing output signals to drive voltage to the sections 102 of the dimming panel 200. The driver 210 can include a regulator, an H-bridge, or substantially any electronic device that supply voltage from a power source (not shown for ease of explanation) to one or more components of the dimming panel 200. For example, MCU 208 can control the sets of switches 204 and/or 206 to activate or deactivate signaling from the driver 210 to control respective sections 102 of the dimming panel 200. In one example, MCU 208 can activate or deactivate switches in the sets of switches 204 and/or 206 based on input received from one or more sensors 104, such as an indication of a location on the display 103 of the display device 101 corresponding to a tracked eye gaze. As described, for example, MCU 208 can use this information to determine one or more sections 102 on which to activate dimming. In another example, which can be combined with the prior example, MCU 208 can determine an amount of dimming, or a corresponding amount of voltage to signal, for providing to the one or more sections 102 of the dimming panel 200 based on an indication of an amount of measured ambient light received from the one or more sensors 104. For example, the voltage can be a function of the measured amount of ambient light. In this regard, for example, MCU 208 can provide a voltage, or a signal to generate a voltage signal, to the driver 210, which can generate the voltage signal for providing to the one or more sections 102. For example, MCU 208 can indicate an amount of voltage to be applied to the dimming panel 200, a light transmittance desired based on the measured amount of ambient light, which the driver 210 can convert to a voltage to achieve the light transmittance, and/or the like. In addition, MCU 208 can also control the sets of switches 204 and/or 206 to leave them open or to close them to allow the voltage signal to pass to the selected sections 102 of the dimming panel 200.

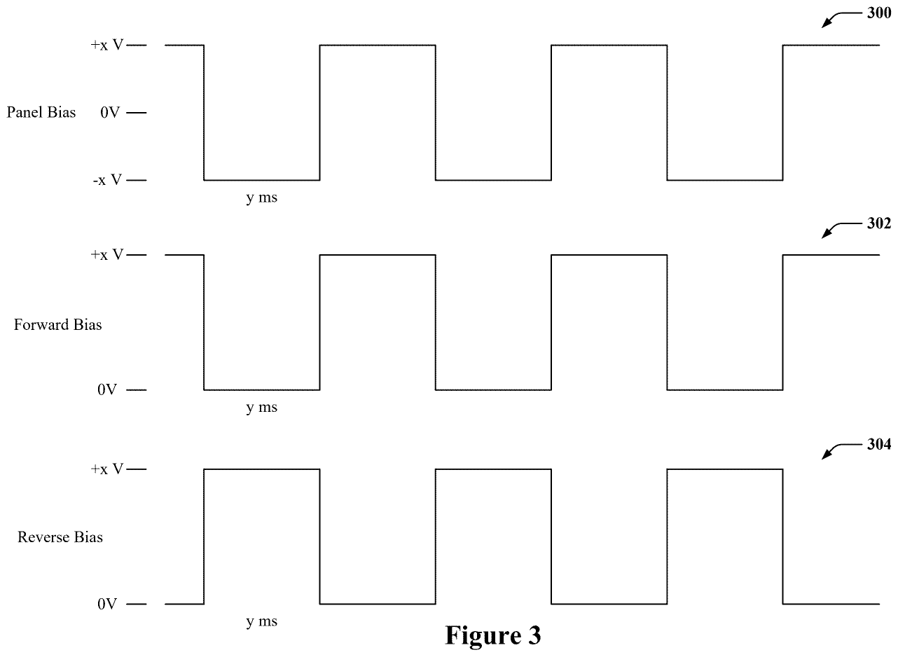

In the example shown in FIG. 2, the sets of switches 204 can be respectively coupled to a positive electrode on one of the sections 102, and the sets of switches 206 can be respectively coupled to a negative electrode on one of the sections 102. In this example, the MCU 208 can, using a single command signal, activate or deactivate a switch in the set of switches 204 corresponding to a positive electrode for a given section and a switch in the set of switches 206 corresponding to a negative electrode on the same given section. The driver 210 can send power control signals having forward bias voltage signal on the line 212 to a positive electrode or a reverse bias voltage on the line 214 to a negative electrode to activate dimming on the corresponding section 102 receiving the power control signals. Using lines 212 and 214, driver 210 can apply a alternating bias voltage to activate dimming on the sections 102, an example of which is shown in FIG. 3. Zero bias voltage can be applied to deactivate dimming.

FIG. 3 illustrates an example of a signal waveform for achieving panel bias 300 by using alternating forward bias 302 and reverse bias 304 over time, in accordance with aspects described herein. The driver 210 can drive voltage signals, using x volts (V), alternating in time (e.g., frequency) by y milliseconds (ms). For example, the driver 210 can send power control signals over the line 212 according to the forward bias 302, and can send power control signals over the line 214 according to reverse bias 304, to achieve the panel bias. The voltage applied, x, can be based on the amount of dimming to be applied, e.g., to achieve a desired level of light transmittance or a desired contrast ratio, which can be based on a function of the measured amount of ambient light, a selectable dimming level parameter, a table of a plurality of ranges of amounts of ambient light and corresponding voltage/dimming to be applied, etc., as described. For example, the voltage can be in proportion to or a function of the measured amount of ambient light and/or in proportion to or a function of the selectable dimming level parameter. Using an alternating bias in this regard can mitigate or reduce material degradation of the materials of the dimming panel 200 (e.g., the LC) that may otherwise be caused by applying a single polarity bias.

Referring back to FIG. 2, in some implementations, processor(s) 106 can store an internal reference or resistor ratio for adjusting the voltage applied by driver 210, such as in cases where the target bias voltage level for achieving a level of light transmittance may be different for different dimming panels. In an example, this internal reference or resistor ratio can be used with the measured amount of ambient light and/or the selectable dimming level parameter to determine the voltage to achieve the desired level of light transmittance and/or contrast ratio of an image at the section(s) 102 of the dimming panel 200.

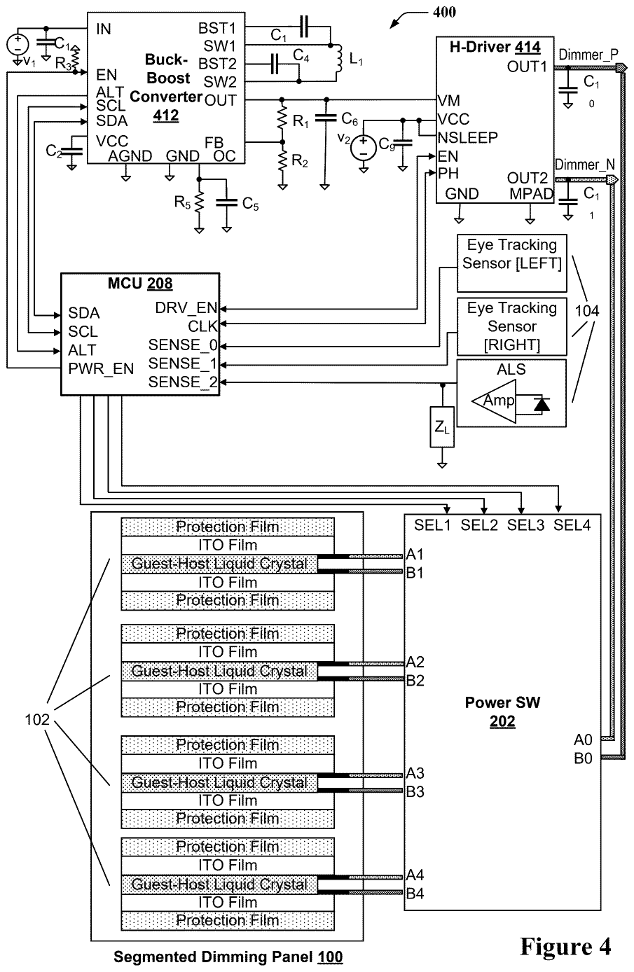

FIG. 4 is a block diagram of an example dimming panel control architecture 400 for use with a display device, in accordance with aspects described herein. For example, dimming panels 100 or 200 can use, or be of, the dimming panel control architecture 400. The context of each of the one or more sensors 104, the power switch 202, the dimming panel 100 (and its one or more sections 102), and the MCU 208 can be as described elsewhere herein. In architecture 400, driver 210 is implemented as a buck-boost converter 412 and a driver 414. The buck-boost converter 412 can be a DC-DC converter that can step up (boost) or step down (buck) an input voltage to a desired output voltage level-e.g., under control of the MCU 208. Buck-boost converter 412 can combine the principles of both buck and boost converters, allowing buck-boost converter 412 to output a voltage that is either higher or lower than the input voltage. This is can be useful in applications where the input voltage can vary, but a stable output voltage can be useful for the driver 414.

FIG. 5 is a flowchart of an example of a method 500 for operating a dimming panel, in accordance with aspects described herein. For example, method 500 can be performed by a dimming panel 100 or 200 and/or one or more components thereof to facilitate dimming sections of the dimming panel, as described herein.

In method 500, at action 502, a first indication of a measured amount of ambient light can be received. In an example, processor(s) 106, MCU 208, e.g., in conjunction with memory/memories 108, etc., can receive the first indication of the measured amount of ambient light. For example, the first indication can be received by the MCU 208 in a signal from one or more sensors 104, such as an ambient light sensor, and may be indicated as a measurement of illuminance (e.g., lux), color temperature, etc. In one example, optionally at action 504, the amount of ambient light can be measured via an ambient light sensor. In an example, processor(s) 106, MCU 208, e.g., in conjunction with memory/memories 108, etc., can measure the amount of ambient light via the ambient light sensor (e.g., one of sensor(s) 104). In this regard, for example, the ambient light sensor may be part of the dimming panel 100 or 200, or the dimming panel may otherwise be configured to request and/or receive the indication of the amount of ambient light from the ambient light sensor.

In method 500, at action 506, a second indication of a location at which an eye is gazing can be received. In an example, processor(s) 106, MCU 208, e.g., in conjunction with memory/memories 108, etc., can receive the second indication of the location at which the eye is gazing. For example, the second indication can be received by the MCU 208 in a signal from one or more sensors 104, and may be indicated as a location on or relative to the dimming panel 100 or 200. In one example, optionally at action 508, the location at which the eye is gazing can be detected via an eye tracking sensor. In an example, processor(s) 106, MCU 208, e.g., in conjunction with memory/memories 108, etc., can detect, via the eye tracking sensor (e.g., one of sensor(s) 104), the location (e.g., on or with respect to the display 103 of the dimming panel 100 or 200 or a display device 101 on which the dimming panel is overlaid or integrated) at which the eye is gazing. In this regard, for example, the eye tracking sensor may be part of the dimming panel 100 or 200, or the dimming panel may otherwise be configured to request and/or receive the indication of the location of eye gaze from the eye tracking sensor. In one example, the dimming panel 100 or 200 can include an eye tracking sensor for the left eye and a separate eye tracking sensor for the right eye. In this example, processor(s) 106 or MCU 208 can receive the location of eye gaze for each of the left eye and the right eye, which can be used to determine which sections of each side of the dimming panel 100 or 200 to apply dimming or otherwise reduce a level of light transmittance of the respective section(s) to account for the measured amount of ambient light.

In method 500, at action 510, a light transmittance in a section of a dimming panel that corresponds to the location can be modified. In an example, processor(s) 106, MCU 208, e.g., in conjunction with memory/memories 108, driver 210, etc., can modify the light transmittance in the section of the dimming panel that corresponds to the location. For example, processor(s) 106 or MCU 208 can modify the light transmittance by activating dimming in the section that corresponds to the location. In one example, processor(s) 106 or MCU 208 can map coordinates of the location of the eye gaze to a section of the dimming panel 100 or 200, which may be based on a mapping table or other indication stored in memory/memories 108 that associates ranges of eye tracking coordinates with corresponding sections 102 of the dimming panel 100 or 200. In another example, processor(s) 106 or MCU 208 can determine the section(s) 102 for dimming based on a location at which an image, e.g., a holographic image, is displayed on a display corresponding to the dimming panel 100 or 200, or a size of the image. In addition, for example, processor(s) 106 or MCU 208 can determine the light transmittance based on the measured amount of ambient light and/or a selectable dimming level parameter and/or the content of the holographic image.

In one example, optionally at action 512, a power control signal can be transmitted to the section of the dimming panel. In an example, processor(s) 106, MCU 208, e.g., in conjunction with memory/memories 108, driver 210, etc., can transmit the power control signal to the section of the dimming panel. For example, processor(s) 106 or MCU 208 can transmit the power control signal by using driver 210 to drive an alternating bias, as described above. Processor(s) 106 or MCU 208 can transmit the power control signal as a voltage to be applied by the driver 210, or as a signal indicating the voltage to be applied. For example, the voltage can correspond to the desired level of light transmittance, which may be based on the measured amount of ambient light. In an example, processor(s) 106 or MCU 208 can determine the light transmittance based on the measured amount of ambient light (and/or the selectable dimming level parameter), and can indicate the light transmittance to the driver 210. The driver 210 can map the light transmittance to a voltage known to substantially achieve the light transmittance at the specific dimming panel 100 or 200, and can transmit the power control signals using forward or reverse bias over time to achieve the panel bias, as described. In an example, the mapping of light transmittance (or ambient light resulting in the light transmittance) to voltage may be stored in a table in memory/memories 108, and can be accessed by the MCU 208 to determine voltage for a corresponding amount of light transmittance.

In one example, optionally at action 514, the sections of the dimming panel to receive a power control signal can be controlled based on the second indication. In an example, processor(s) 106, MCU 208, e.g., in conjunction with memory/memories 108, driver 210, etc., can control, based on the second indication, which sections of the dimming panel receive the power control signal. As described, processor(s) 106 or MCU 208 can control the sections based on respective switches, or sets of switches (such as the first set of switches 204 and/or the second set of switches 206). For example, processor(s) 106 or MCU 208 can determine the section(s) that corresponds to the location(s) of eye gaze provided by the eye tracking sensor(s), and can activate one or more switches for the sections 102 (e.g., a switch for a positive terminal and a switch for a negative terminal), such that the section(s) 102 can receive the power control signal, which may include the alternating bias voltage on the positive and negative terminals of the section(s) 102.

In method 500, optionally at action 516, a brightness of a display can be adjusted based on modifying the light transmittance. In an example, processor(s) 106, MCU 208, e.g., in conjunction with memory/memories 108, etc., can adjust, based on modifying the light transmittance, the brightness of the display. For example, where the dimming panel 100 is part of a display device 100, MCU 208 can adjust the brightness of the display 103 to an amount that is based on the light transmittance. For example, where the dimming panel 100 is a separate device, MCU 208 can send an instruction or information to the display device 100, over a communication channel between the dimming panel 100 and display device 100, indicating the amount of light transmittance, an amount to adjust the brightness, and/or the like, based on which the display device 100 can adjust the brightness of display 103. In one example, the table that maps light transmittance (or ambient light resulting in the light transmittance) to voltage may also map the light transmittance (or ambient light resulting in the light transmittance) to brightness level or amount, and this brightness level or amount can be used to adjust the brightness of the display.

Some further example aspects are provided below.

Aspect 1 is a method for controlling a dimming panel for a display device including receiving a first indication of a measured amount of ambient light, receiving a second indication of a location at which an eye is gazing, and transmitting, to a section of the dimming panel that corresponds to the location, a power control signal to modify a light transmittance.

In Aspect 2, the method of Aspect 1 includes controlling, based on the second indication, which sections of the dimming panel receive the power control signal.

In Aspect 3, the method of any of Aspects 1 or 2 includes executing a dimming panel driver to transmit, based on the first indication, the power control signal to the dimming panel, and activating, based on the second indication, a switch that corresponds to the section of the dimming panel to receive the power control signal.

In Aspect 4, the method of any of Aspects 1 to 3 includes where the power control signal includes an alternating bias voltage signal transmitted on positive and negative terminals of to the section of the dimming panel.

In Aspect 5, the method of any of Aspects 1 to 4 includes where a voltage corresponding to the power control signal is a function of the measured amount of ambient light.

In Aspect 6, the method of Aspect 5 includes where the voltage corresponding to the power control signal is further a function of a selectable dimming level parameter.

In Aspect 7, the method of any of Aspects 1 to 6 includes where the section of the dimming panel further corresponds to second location on the display device at which an image is displayed.

In Aspect 8, the method of any of Aspects 1 to 7 includes receiving a third indication of a second location at which a second eye is gazing, and transmitting, to the dimming panel and based on the first indication and the third indication, to a second section of the dimming panel that corresponds to the second location on the display device, the power control signal to modify the light transmittance.

In Aspect 9, the method of any of Aspects 1 to 8 includes receiving the first indication from an ambient light sensor.

In Aspect 10, the method of any of Aspects 1 to 9 includes receiving the second indication from an eye tracking sensor.

In Aspect 11, the method of any of Aspects 1 to 10 includes adjusting, based on the amount of light transmittance, an amount of brightness of a display of the display device.

Aspect 12 is an apparatus including one or more processors, one or more memories coupled with the one or more processors, and instructions stored in the one or more memories and operable, when executed by the one or more processors, to cause the apparatus to perform any of the methods of Aspects 1 to 11.

Aspect 13 is an apparatus for including means for performing any of the methods of Aspects 1 to 11.

Aspect 14 is one or more computer-readable media including code executable by one or more processors, the code including code for performing any of the methods of Aspects 1 to 11.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium, such as a non-transitory computer-readable medium. Computer-readable media includes computer storage media. Storage media may be any available media that can be accessed by a computer. By way of example, and not limitation, such computer-readable media can comprise random access memory (RAM), read only memory (ROM), electrically erasable programmable ROM (EEPROM), CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. An apparatus for controlling a dimming panel for a display device, comprising:
one or more processors configured to:
receive a first indication of a measured amount of ambient light;
receive a second indication of a location on the display device at which an eye is gazing;
select, based on the location on the display device, a section from multiple sections of the dimming panel; and
modify a light transmittance in the section of the dimming panel that corresponds to the location including applying a voltage to liquid crystal in the section to individually activate the liquid crystal in the section causing a dimming effect.

2. The apparatus of claim 1, wherein each section of the multiple sections includes electrodes for supplying power to the section, and wherein the one or more processors are configured to modify the light transmittance individually in the section by transmitting a power control signal to the electrodes of the section of the dimming panel.

3. The apparatus of claim 2, wherein the one or more processors are configured to control, based on the second indication, which sections of the dimming panel receive the power control signal.

4. The apparatus of claim 2, wherein the one or more processors are configured to:
execute a dimming panel driver to transmit, based on the first indication, the power control signal to the dimming panel; and
activate, based on the second indication, a switch that corresponds to the section of the dimming panel to receive the power control signal.

5. The apparatus of claim 2, wherein the power control signal includes an alternating bias voltage signal transmitted on positive and negative terminals of the section of the dimming panel.

6. The apparatus of claim 2, wherein a voltage corresponding to the power control signal is a function of the measured amount of ambient light.

7. The apparatus of claim 6, wherein the voltage corresponding to the power control signal is further a function of a selectable dimming level parameter.

8. The apparatus of claim 1, wherein the section of the dimming panel further corresponds to a second location on the display device at which an image is displayed.

9. The apparatus of claim 1, wherein the one or more processors are configured to:
receive a third indication of a second location at which a second eye is gazing; and
modifying the light transmittance in a second section of the dimming panel that corresponds to the second location.

10. The apparatus of claim 1, further comprising an ambient light sensor, wherein the one or more processors are configured to receive the first indication from the ambient light sensor.

11. The apparatus of claim 1, further comprising an eye tracking sensor, wherein the one or more processors are configured to receive the second indication from the eye tracking sensor.

12. The apparatus of claim 1, wherein the one or more processors are further configured to adjust, based on an amount of the light transmittance and in addition to modifying the light transmittance, an amount of brightness of a display of the display device.

13. A method for controlling a dimming panel for a display device, comprising:
receiving a first indication of a measured amount of ambient light;
receiving a second indication of a location on the display device at which an eye is gazing;
selecting, based on the location on the display device, a section from multiple sections of the dimming panel; and
transmitting, to the section of the dimming panel that corresponds to the location, a power control signal to modify a light transmittance including applying a voltage to liquid crystal in the section to individually activate the liquid crystal in the section causing a dimming effect.

14. The method of claim 13, further comprising individually controlling, based on the second indication, which sections of the dimming panel receive the power control signal.

15. The method of claim 13, further comprising:
executing a dimming panel driver to transmit, based on the first indication, the power control signal to the dimming panel; and
activating, based on the second indication, a switch that corresponds to the section of the dimming panel to receive the power control signal.

16. The method of claim 13, wherein the power control signal includes an alternating bias voltage signal transmitted on positive and negative terminals of the section of the dimming panel.

17. The method of claim 13, wherein a voltage corresponding to the power control signal is a function of the measured amount of ambient light.

18. The method of claim 17, w herein the voltage corresponding to the power control signal is further a function of a selectable dimming level parameter.

19. The method of claim 13, wherein the section of the dimming panel further corresponds to a second location on the display device at which an image is displayed.

20. A non-transitory computer-readable device storing instructions thereon that, when executed by a computing device, cause the computing device to perform operations for controlling a dimming panel for a display device, comprising:
receiving a first indication of a measured amount of ambient light;
receiving a second indication of a location on the display device at which an eye is gazing;
selecting, based on the location on the display device, a section from multiple sections of the dimming panel; and
transmitting, to the section of the dimming panel that corresponds to the location, a power control signal to modify a light transmittance including applying a voltage to liquid crystal in the section to individually activate the liquid crystal in the section causing a dimming effect.

21. The apparatus of claim 1, wherein the one or more processors are configured to select the section based on mapping coordinates of the location at which the eye is gazing to the section using a mapping table stored in memory that associates ranges of eye tracking coordinates with corresponding sections of the dimming panel.

22. The apparatus of claim 2, wherein the one or more processors are configured to transmit the power control signal by alternating forward bias voltage signals on a positive electrode of the section and reverse bias voltage signals on a negative electrode of the section over time.
